(19) United States
(12) Patent Application Publication
(10) Pub. No.: US 2011/0254667 A1
(43) Pub. Date: Oct. 20, 2011

(54) STRING MATERIAL WITH RADIO FREQUENCY IDENTIFICATION TAGS

(75) Inventor: Valentin Popescu, Tomball, TX (US)

(73) Assignee: HEWLETT-PACKARD DEVELOPMENT COMPANY, L.P., Houston, TX (US)

(21) Appl. No.: 12/762,026

(22) Filed: Apr. 16, 2010

(51) Int. Cl. G06K 7/01; G06F 17/00; G06K 19/067

(52) U.S. Cl. 340/10.42; 235/492; 235/375

(57) ABSTRACT

A product includes a string material; and a series of Radio Frequency Identification (RFID) tags secured along a length of the string material. Each RFID tag has an identifier stored therein for transmission to identify that RFID tag and a path along the string material to a reader. A method includes laying a string material along a path through an infrastructure, the string material comprising Radio Frequency Identification (RFID) tags placed at intervals along a length of the string material. Each said RFID tag has an identifier stored therein for transmission to identify that RFID tag to a reader. The path is selected to correspond with a path to be followed through the infrastructure by a computer-driven mobile device.

### BACKGROUND

Computer-controlled or computer-driven mobile devices, such as mobile robotic devices, are often configured to navigate complex routes through hallways, along roadways and other infrastructure systems. These computer-driven mobile devices may obtain their position within their environment through various technologies such as Global Positioning Systems (GPS) and infrared systems. These types of technologies may be relatively costly and, in some environments, may not be practical.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram showing illustrative RFID tag principles, according to one embodiment of principles described herein.

FIG. 2 is a diagram showing an illustrative string material having RFID tags embedded therein, according to one embodiment of principles described herein.

FIG. 3 is a diagram showing an illustrative section of RFID tape having sequentially numbered RFID tags, according to one embodiment of principles described herein.

FIG. 4 is a diagram showing an illustrative infrastructure having multiple routes, according to one embodiment of principles described herein.

FIG. 5 is a diagram showing an illustrative infrastructure having multiple paths, according to one embodiment of principles described herein.

FIG. 6 is a diagram showing illustrative RFID tape layers, according to one embodiment of principles described herein.

FIG. 7A is a diagram showing an illustrative computer-driven mobile device, according to one embodiment of principles described herein.

FIG. 7B is a diagram showing an illustrative computer-driven mobile device moving along a path having an RFID string material embedded therein, according to one embodiment of principles described herein.

FIG. 8 is a diagram showing an illustrative method for augmenting an infrastructure, according to one embodiment of principles described herein.

Throughout the drawings, identical reference numbers designate similar, but not necessarily identical, elements.

### DETAILED DESCRIPTION

One solution which may be used to help computer-driven mobile devices navigate their environment is the use of Radio Frequency Identification (RFID) tags. RFID tags are small devices which are configured to emit a low powered radio wave in response to provocation by an RFID tag reader. The emitted radio wave may be used to transmit a small amount of data stored within a memory structure of the RFID tag. RFID tags may be placed throughout an environment to be traversed by a computer-driven mobile device. In such an environment, the computer-driven mobile device may be fitted with an RFID tag reader. The tag reader may be able to retrieve data from nearby RFID tags and determine the relative location of the computer-driven mobile device.

While RFID tags generally offer a low cost solution, they are often more difficult to implement. This is because the RFID tags must be placed throughout the environment in which the computer-driven mobile device will be operating. Furthermore, the computer-driven mobile device must be programmed with a database storing the location of every RFID tag within the environment.

In light of these and other issues, the present specification relates to a method for easily augmenting an infrastructure with RFID tags. Additionally, a method or system embodying principles described herein may allow a computer-driven mobile device to be easily configured to traverse the augmented infrastructure.

According to certain illustrative embodiments, a string material such as tape or rope may be fitted with a number of RFID tags placed at relatively regular intervals. The RFID tags may be assigned identification numbers in a manner such that successive RFID tags along the length of the string material follow a particular number sequence. Such a string material fitted with RFID tags may be placed along various routes within an infrastructure.

With such an infrastructure in place, a computer-driven mobile device may then be programmed with the identification number of the RFID tag associated with a starting point and the identification number of the RFID tag associated with a destination point of a route within the infrastructure. The computer-driven mobile device may then follow the sequence from the starting RFID tag to the destination RFID tag.

Through use of a system or method embodying principles described herein, an infrastructure may be easily augmented with RFID tags. By placing the RFID tags in a string material such as a tape, rope or cord, the RFID tags may be easily placed along or inside of existing structures within the infrastructure. Additionally, a computer-driven mobile device configured to traverse the infrastructure may need only the identification number of the starting RFID tag and the destination RFID tag. Furthermore, passive RFID tags are inexpensive and do not consume power. A sting material fit with passive RFID tags may also be cut and spliced without affecting the operation of the passive RFID tags.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Throughout this specification and in the appended claims, the term “string material” is to be broadly interpreted as an elongated flexible material such as, but not limited to, a tape, rope, or cord. A string material may have a cross sectional shape of any practical form.

Throughout this specification and in the appended claims, the term “infrastructure” is to be broadly interpreted as a physical structure through which a mobile device may traverse from a starting point to a destination point. An infrastructure may include multiple routes and paths between multiple starting points and destination points.

Throughout this specification and in the appended claims, the term “computer-driven mobile device” is to be broadly interpreted as a device having a means of mobility operated by a physical computing system. The computing system may be on-board the mobile device, may be communicating remotely with the mobile device, or may have components both on and off the mobile device. The means of mobility may include, but is not limited to, wheels, tracks, and legs.

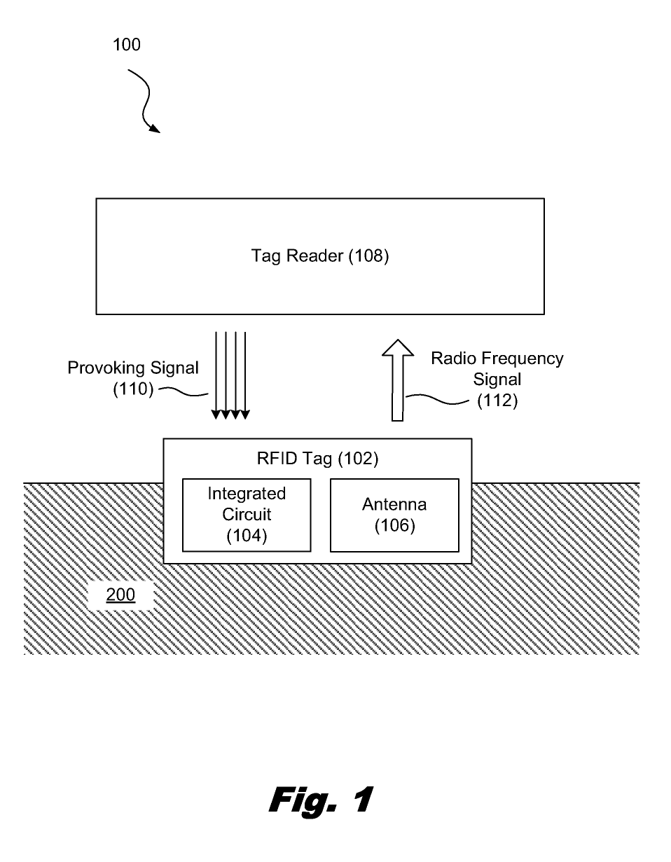

Referring now to the figures, FIG. 1 is a diagram showing an illustrative RFID tag system (100). According to certain illustrative embodiments, an RFID tag (102) may include an integrated circuit (104) and an antenna (106). An RFID tag is typically used in conjunction with a tag reader (108). Some RFID tags (102) may include their own power source. Such RFID tags (102) may be referred to as active RFID tags. Some RFID tags (102) may not have a power source of their own. Such RFID tags (102) may be referred to as passive RFID tags. A passive RFID tag may derive power from an electric field emanating from the tag reader (108).

The integrated circuit (104) associated with an RFID tag (102) may be used to provide a number of important functions. One such function is storing identification data. Various memory structures formed within the integrated circuit (104) may be used to store the identification data. Another function of the integrated circuit is to modulate the identification data for transmission via the antenna (106). A modulation process typically involves varying an analog waveform in response to a received digital signal.

An antenna (106) is typically comprised of a conductive strip. The physical shape of the conductive strip may depend on the design requirements of the antenna (106). In general, an antenna (106) transforms an electric signal into a Radio Frequency (RF) signal (112). An RF signal (112) is an electromagnetic wave of a specific frequency range. RF signals (112) may generally range from 3 kHz to 300 GHz. The frequency at which an antenna (106) transmits a signal is generally dependent on the antenna's (106) shape and design. Additionally, an antenna (106) may be designed to emit an RF signal (112) in a particular direction.

A tag reader (108) is used to receive the RF signal (112) emanating from the RFID tag (102). The tag reader (108) may include circuitry configured to demodulate the received RF signal (112) and obtain the identification data from the RFID tag (102) in a digital format. The tag reader (108) may also include a means for transmitting a provoking signal (110) to the RFID tag (102). The provoking signal (110) may inform the RFID tag (102) that the tag reader (108) is near. The RFID tag (102) may then begin to transmit the identification data.

As mentioned above, some RFID tags (102) are passive RFID tags and thus do not have their own power supply. Such RFID tags (102) may be powered by the tag reader (108). The tag reader (108) may produce an electric field which is strong enough to power the passive RFID tag. Such a transfer of power generally requires a close proximity of the tag reader (108) to the RFID tag (102). The minimum distance between the tag reader (108) and the RFID tag (102) required to activate the RFID tag (102) may depend on the strength of the electric field produced by the tag reader (108).

According to various embodiments of the principles disclosed in this specification, the RFID tag (102) may be one of a series of such tags embedded in, or disposed on, a string material (200). Such embodiments of the principles disclosed will now be described in greater detail.

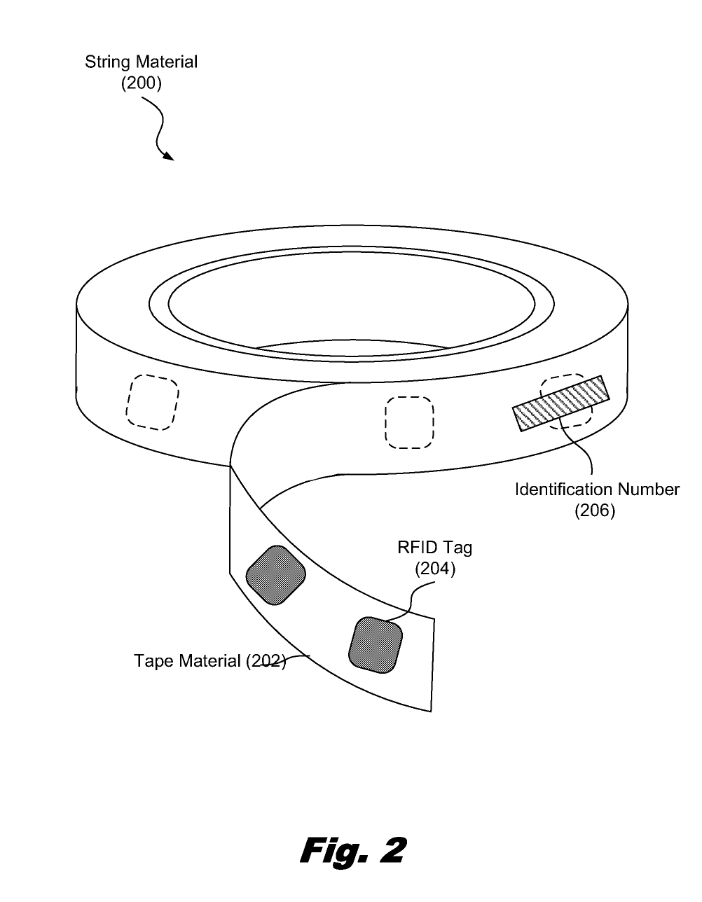

FIG. 2 is a diagram showing an illustrative string material (200) having RFID tags (204) embedded therein. According to certain illustrative embodiments, RFID tags (204) may be placed within a tape material (202). The tape material may have an adhesive applied on at least one side to allow the tape to be secured along a desired route and be rolled, prior to deployment, into a roll. In some embodiments, the identification number (206) assigned to each RFID tag (204) may be printed onto the tape material in close proximity to the associated RFID tag (204). In some embodiments, the printed identification number may be in the form of a barcode.

The use of RFID tags (204) embedded into a tape material (202) disposed around a roll may allow for easy augmentation of an infrastructure. For example, to layout a route through the infrastructure, one may simply lay the tape along the desired route. In the case that a computer-driven mobile device is configured to navigate the hallways of a building, the tape may be laid out along a floor, a wall, or a ceiling of the building along the desired route. In some uses, the tape may be laid out during the construction of the building. Doing so may allow the tape to be painted over or covered by more aesthetically pleasing material. The tape roll embodiment may also be used to augment infrastructures long after the construction process. If desired, various means may be used to conceal the tape material (202).

In some embodiments, as the RFID tags (204) are being placed within a tape material (202) during the manufacturing process, a printing device may print the assigned identification number (206) of each RFID tag (204) onto the tape material (202) in proximity to the associated RFID tag (204). The RFID tags may also be assigned their appropriate identification number during this process. Some RFID tags (204) may be assigned or reassigned identification number by a special type of tag reader. As may be appreciated by those skilled in the relevant art, there may be many ways to configure the integrated circuitry of the RFID tags (204) to have the capability of reassigning identification numbers (206).

By having the identification numbers (206) printed onto the tape material, it may be easy to take note of what the identification numbers are for the RFID tags (204) at a desired starting point and a desired destination point. The identification numbers (206) for the RFID tags (204) at particular relevant locations may be noted during the construction process of an infrastructure, before the tape material is painted or covered. Additionally or alternatively, a tag reader may be used to determine the identification number of the RFID tags (204) at the relevant locations. If the printed identification numbers are in the form of barcodes, a barcode reader may be used to determine the identification numbers of the RFID tag (204) at the relevant location.

In some embodiments, the string material (200) may have a cord-like structure. The cord-like structure may be wound around a wheel. Such an embodiment will also allow for easy augmentation of an infrastructure. For example, many buildings already have structures designed through which wires are run through walls, ceilings, along pipes, and in between floors. The cord-like structured material fitted with RFID tags may be laid through such existing structures. Similarly to using a tape material fitted with RFID tags, one may take note of the RFID tags at the relevant locations using a tag reader or printed identification number (206). One benefit of using a cord-like structure is that it may be pulled through a wall or ductwork by using fishing methods which are commonly used to pull electrical wires.

In some embodiments, the string material may be laid out along roadways. Computer-driven mobile devices fit to carry passengers may use the string material with RFID tags to navigate the roadways.

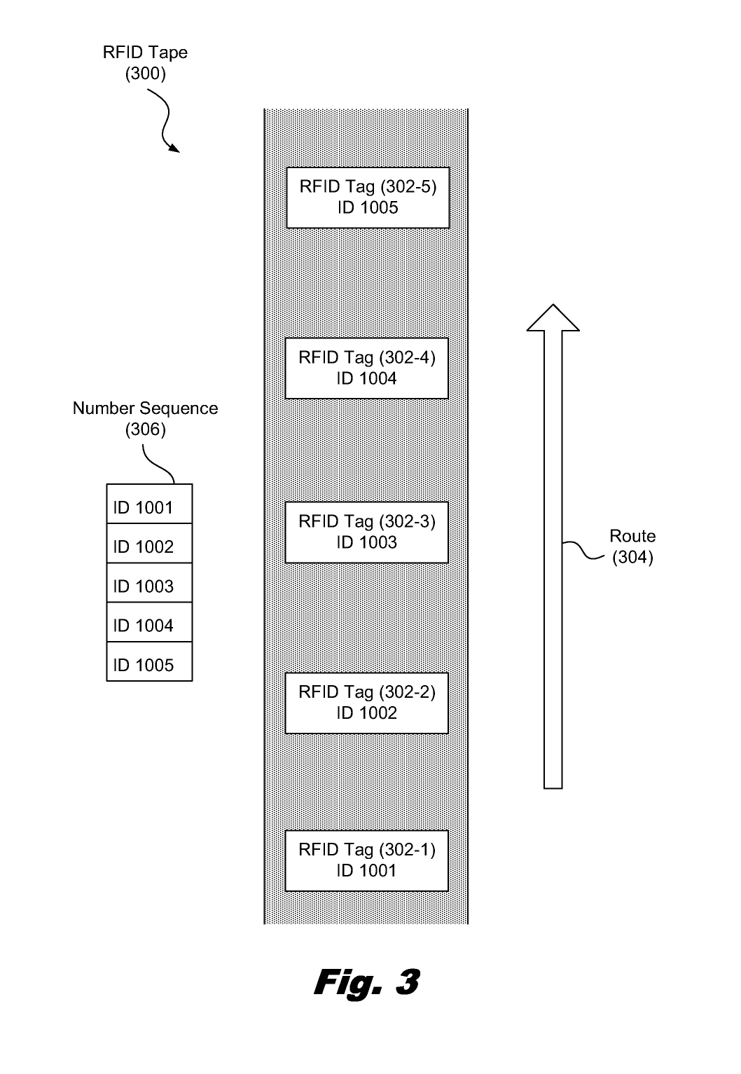

FIG. 3 is a diagram showing an illustrative section of RFID tape (300) having sequentially numbered RFID tags (302). As mentioned above, RFID tags (302) may be placed at generally regular intervals along the string material. According to certain illustrative embodiments, successive RFID tags (302) placed along the RFID tape (300) may be assigned identification numbers according to a number sequence (306).

The number sequence assigned to successive RFID tags (302) may be any suitable number sequence that follows a given pattern. In some embodiments, the identification numbers may follow a direct numerical sequence. For example, the RFID tag (302-1) at a starting location may have an identification number 1001. The RFID tag (302-5) at the destination location may have an identification number of 1005. A computer-driven mobile device may be programmed with the starting identification number 1001 and the destination identification number 1005. As the computer-driven mobile device moves along the route (304), it may be configured to pass RFID tags (302-2, 302-3, 302-4) having identification numbers 1002, 1003, and 1004, in numeric sequence, until the destination is reached.

In some embodiments, the RFID tags may be configured with more than one identification number. A given strip of string material fitted with RFID tags may contain more than one number sequence. For example, a given RFID tag may be assigned one identification number as part of a first number sequence and a second identification number as part of a second number sequence.

The computer-driven mobile device may also be programmed with the characteristics of the number sequence (306). For example, when the computer-driven mobile device passes the RFID tag (302-2) with the identification number 1002, the mobile device may know that the next RFID tag (302-3) along the route (304) has an identification number of 1003. In some cases, an RFID tag may be damaged or otherwise inoperable. The computing system of a computer-driven mobile device may be programmed to determine the next number in the sequence, if a number is missing.

The number sequence (306) used by successive RFID tags (302) may be any suitable number sequence. For example, the number sequence may be only even or odd numbers, multiples of a number (such as counting by 5's or 10's) or a reverse numerical sequence. Alternatively, the number sequence may be such that a function is applied to a given number to obtain the next number in the sequence. A computer-driven mobile device may be programmed with that function in order to determine what the next number in the sequence is. Thus allowing the mobile device to determine the proper route (304).

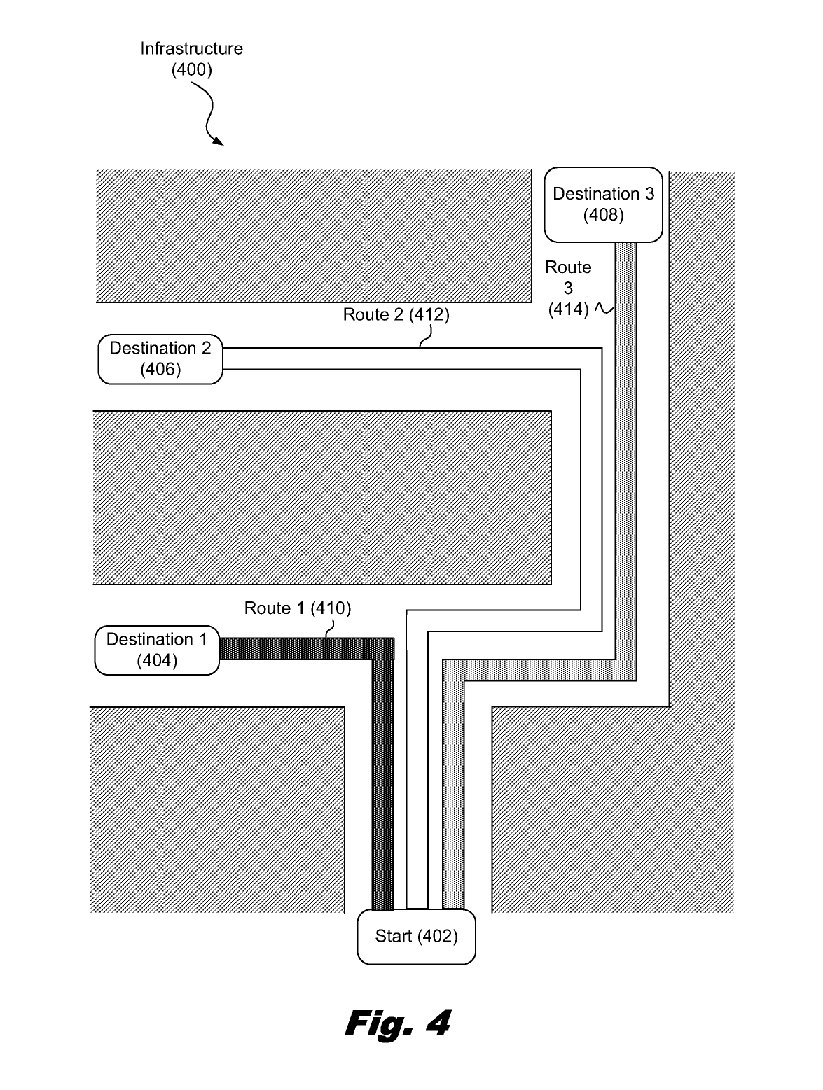

FIG. 4 is a diagram showing an illustrative infrastructure (400) having multiple routes. According to certain illustrative embodiments, an infrastructure (400) may include a number of routes (410, 412, 414) going from a start point (402) to a destination point (404, 406, 408). The string material having been fitted with RFID tags may be laid down along each route (410, 412, 414).

A computer-driven mobile device may be initially placed at the start point (402). It may then be programmed to traverse one of three routes (410, 412, 414). If the mobile device intends to traverse route 1 (410), then it may be given the identification number of the RFID tag at the start of route 1 (410) as well as the identification number for the RFID tag at destination 1 (404). The mobile device may then be able to traverse route 1 (410) by following the number sequence between the start point (402) and destination 1 (404). The same principle of operation may allow the mobile device to traverse route 2 (412) and route 3 (414) to reach destination 2 (406) and destination 3 (408). The mobile device may need only the start point RFID tag identification numbers for the routes (412, 414) and the RFID tag identification numbers for the destination points (406, 408).

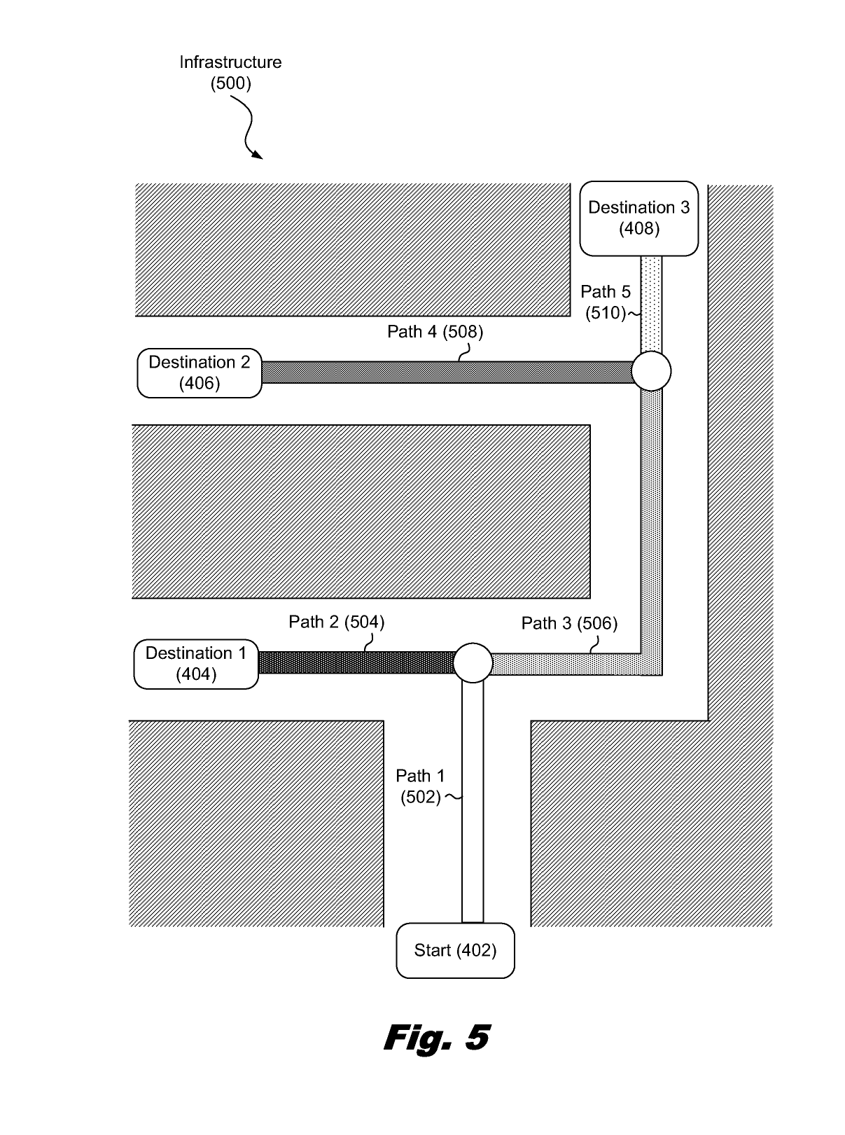

FIG. 5 is a diagram showing an illustrative infrastructure (500) having multiple paths. According to certain illustrative embodiments, the routes between a starting point and various destinations may include a number of paths. Each path may be laid with the string material having been fitted with RFID tags. A path arrangement as shown in FIG. 5 may reduce the amount of string material required to augment the infrastructure.

A computer-driven mobile device may be initially located at the start point (402). If the mobile device is intending to reach destination 1 (404), then it may be programmed with the starting and ending RFID tag identification numbers for both path 1 (504) and path 2 (504). The mobile device may then follow the sequence for path 1 (502) until reaching the intersection. The mobile device may then follow the number sequence for path 2 (504) until it reaches destination 1 (404). To reach destination 2 (406), the mobile device may be programmed with the starting and ending RFID tag identification numbers for path 1 (502), path 3 (506), and path 4 (508). Likewise, to reach destination 3 (408), the mobile device may be programmed with the starting and ending RFID tag identification numbers for path 1 (502), path 3 (506), and path 5 (510).

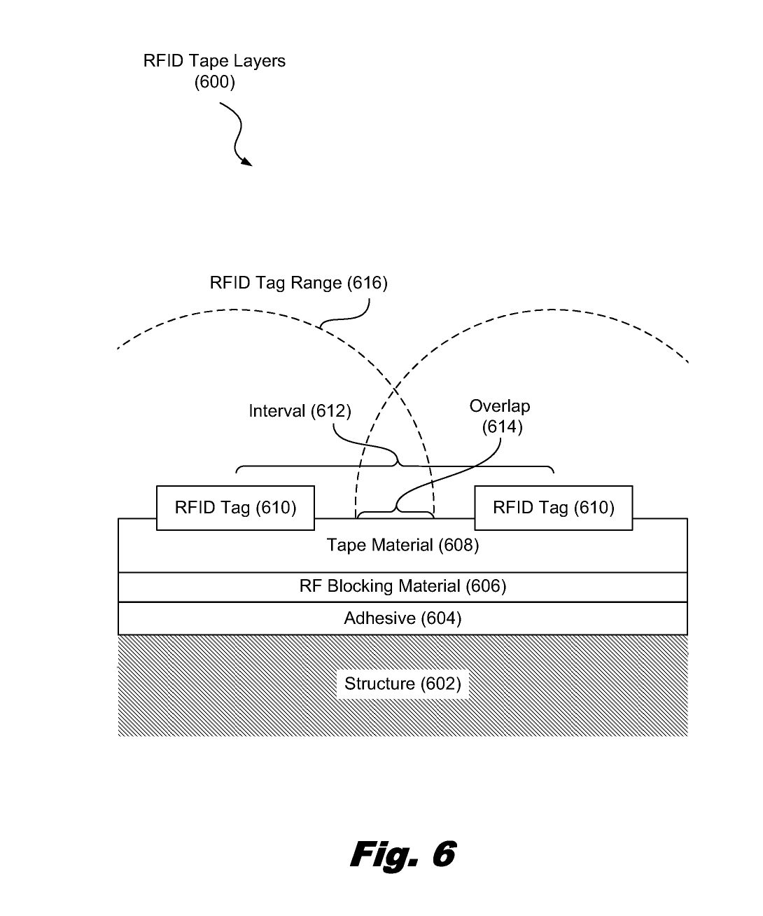

FIG. 6 is a diagram showing illustrative RFID tape layers (600). According to certain illustrative embodiments, the string material may be of a tape form. The tape form may include an adhesive (604), an RF blocking material (606), the actual tape material (608), and a number of RFID tags (610). The RFID tags (610) may be placed at specific intervals (612) so that their ranges (616) create an overlap (614).

The adhesive (604) may be any suitable substance for bonding one material to another. The chemical properties of the adhesive (604) may depend on the structure to which the tape material (608) is to be adhered. For example, some structures may have rough services and are not easily adhered to using moderate adhesive substances. Stronger adhesive substances may be needed in such cases.

In some embodiments, it may be beneficial to provide an RF blocking material (606) somewhere between the RFID tags (610) and the structure to which the tape material (608) is adhered. These benefits may be realized in the case that an infrastructure includes multiple levels. It may be desired that RF signals from the RFID tags (610) on one level not interfere with the RF signals from RFID tags (610) on an alternate level. RF blocking material (606) is generally an electrically conductive material. As the electromagnetic waves of the RF signal reach the conductive surface, the energy from the electromagnetic waves is transferred to electric current within the RF blocking material (606). Those skilled in the relevant art will be able to make use of the proper materials to sufficiently block RF signals.

The tape material (608) itself may be made of standard tape material. Some materials may be plastic-based while other materials may be fabric-based or paper-based. In FIG. 6, the RFID tags (610) are shown protruding from the tape material (608). However, in some embodiments, the RFID tags may be completely buried within the tape material. Such embodiments may allow the tape material to more easily be wrapped around a tape roll. In other embodiments, the RFID tags may rest entirely on top of the surface of the supporting string material.

The intervals (612) at which RFID tags (610) may be placed along a string material may depend on the environment in which the string material is to be placed. For example, some infrastructures are also laid with wiring configured to carry power and data signals. Such wiring may reduce the strength of the RF signals emitting from the RFID tags (610) and thus reduce their effective range (616). The intervals at which the RFID tags are placed along the string material may also be designed so that an overlap (614) of ranges (616) exists between successive RFID tags (610). Thus, there may be a point at which a computer-driven mobile device may be receiving RF signals from two RFID tags (610). This may help the mobile device to determine which direction it should go to stay along its intended route.

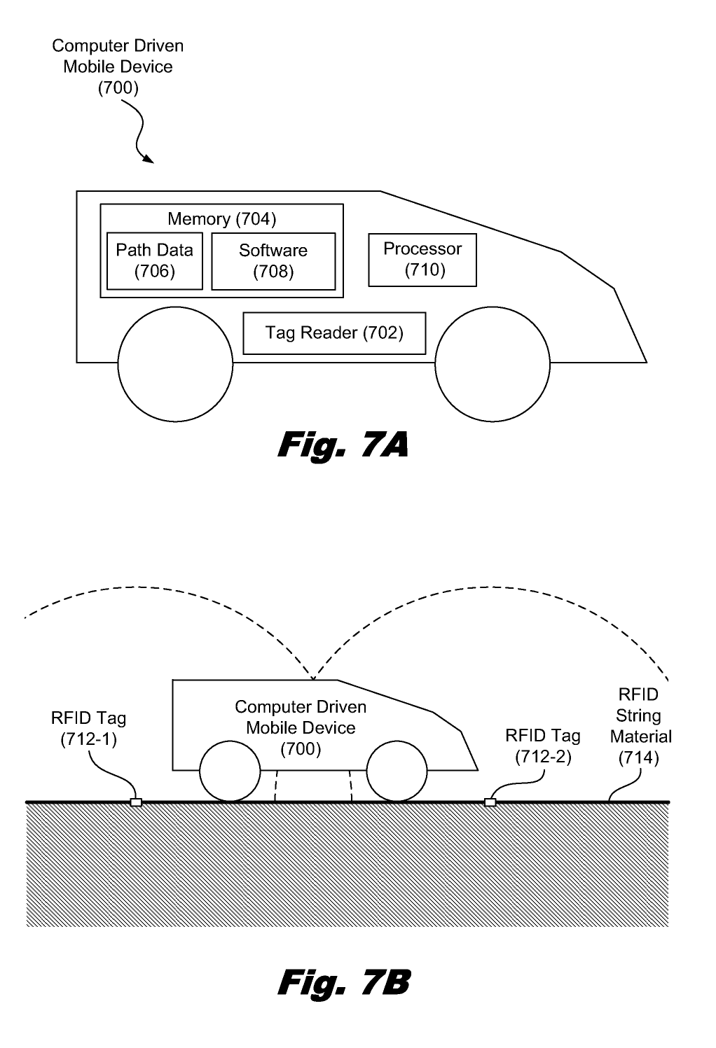

FIG. 7A is a diagram showing an illustrative computer-driven mobile device (700). According to certain illustrative embodiments, a computer-driven mobile device (700) may include a memory having path data (706) and software (708) stored thereon, a processor (710), and a tag reader (702). FIG. 7A illustrates a computer-driven mobile device (700) having wheels as a means of mobility. However, a computer-driven mobile device (700) embodying principles described herein may have other mobility means such as legs or tracks. Furthermore, a computer-driven mobile device is not limited to the shape illustrated in FIG. 7A.

Physical computing systems typically comprise a form of computer memory (704). There are many different types of memory which a computing system may employ. These different types of memory may be categorized as volatile memory and non-volatile memory. Volatile memory is generally able to operate at a fast rate but loses its data when power is no longer being supplied. Non-volatile memory may operate at a slower rate but is able to retain its data when power is no longer being supplied. The memory (704) of the computer-driven mobile device (700) may store path data (706) as well as the software (708) necessary to operate the hardware associated with the mobile device.

The path data (706) may include the identification numbers for the RFID tags placed at the starting and ending location of each path throughout the infrastructure. The path data (706) may also include the characteristics of the number sequence used by each path. Additionally, the path data (706) may include a number of routes through the infrastructure, each route including a number of paths.

Software (708) is generally defined as a set of instructions which cause a processor to perform a sequence of tasks to produce a desired processing result. The software (708) of the computer-driven mobile device (700) may cause the processor to operate the mobility means of the mobile device (700) to navigate the device to its intended locations. The software (708) may also process the data received by the tag reader (702) from the RFID tags along a path. The software (708) may include instructions to manage the path data (706).

FIG. 7B is a diagram showing an illustrative computer-driven mobile device (700) moving along a path having an RFID string material (714) embedded therein. As mentioned above, the computer-driven mobile device (700) may be configured to navigate through an infrastructure along routes defined by a strip of RFID tag (712) fitted string material (714).

In one example of operation, the computer-driven mobile device (700) may be moving along a path by following a strip of RFID string material (714). The computer-driven mobile device (700) may reach a point where it is in range of two RFID tags (712-1, 712-2). One RFID tag (712-1) may be the one which the mobile device (700) has recently passed. The other RFID tag (712-2) may be the one which the mobile device (700) should pass next. After the mobile device has passed the first RFID tag (712-1) and read its identification number, the mobile device (700) may determine the next identification number in the number sequence given to the current path being traversed. When in range of the second RFID tag (712-2), the mobile device (700) may confirm that it is on proper course along the intended path.

Throughout this specification and in the accompanying drawings, the string material is often illustrated and described as a tape format. However, a method or system embodying principles described herein may be applied to other string-like structures such as rope structures and cord structures.

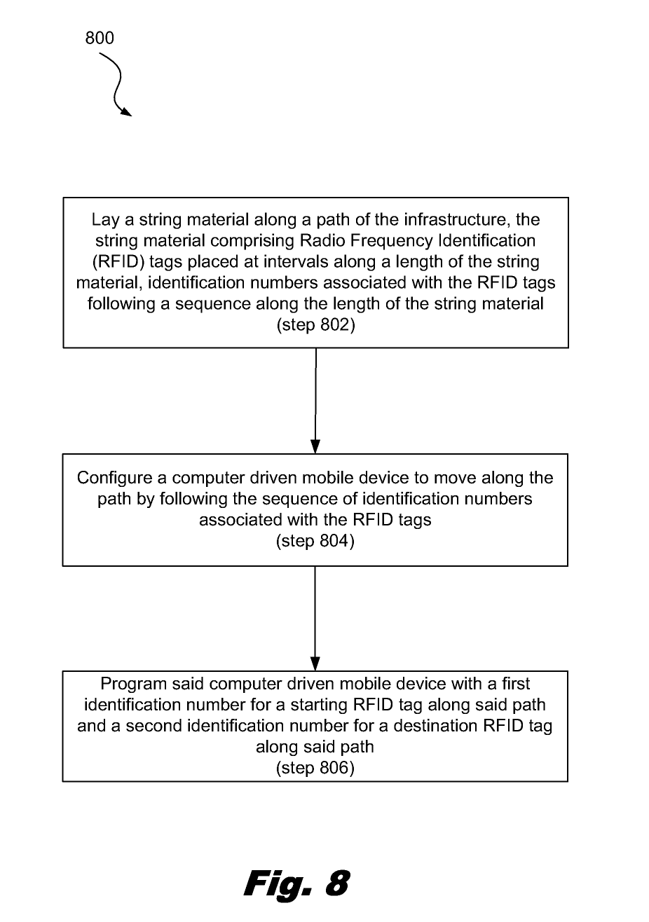

FIG. 8 is a diagram showing an illustrative method (800) for augmenting an infrastructure. According to certain illustrative embodiments, laying (step 802) a string material along a path of the infrastructure, the string material comprising Radio Frequency Identification (RFID) tags placed at intervals along a length of the string material, identification numbers associated with the RFID tags following a sequence along the length of the string material; and configuring (step 804) a computer-driven mobile device to move along the path by following the sequence of identification numbers associated with the RFID tags. The method may further include programming (step 806) a computer-driven mobile device with a first identification number for a staring RFID along the path and a second identification number for a destination RFID along the path.

In sum, through use of a system or method embodying principles described herein, an infrastructure may be easily augmented with RFID tags. By placing the RFID tags in a string material such as a tape, rope or small tubing, the RFID tags may be easily placed along or inside of existing structures within the infrastructure. Additionally, a computer-driven mobile device configured to traverse the infrastructure may need only the identification number of the starting RFID tag and the destination RFID tag. Furthermore, RFID tags are inexpensive and generally do not consume power.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A product comprising:
a string material; and
a series of Radio Frequency Identification (RFID) tags secured along a length of said string material,
each said RFID tag having an identifier stored therein for transmission to identify that RFID tag and a path along said string material to a reader.

2. The product of claim 1, in which said RFID tags are secured at regular intervals along said string material.

3. The product of claim 1, in which said identifiers of said RFID tags follow a numeric sequence along said length of said string material.

4. The product of claim 1, in which each said identifier is printed on said string material adjacent a corresponding said RFID tag.

5. The product of claim 1, in which each said identifier is denoted by a bar code printed on said string material adjacent a corresponding said RFID tag.

6. The product of claim 1, in which said string material comprises a tape with an adhesive applied on at least a portion of said tape.

7. The product of claim 1, in which said RFID tags are passive RFID tags.

8. The product of claim 1, in which a transmission range of each RFID tag on said string material overlaps a transmission range of an adjacent RFID tag on said string material.

9. The product of claim 1, in which said RFID tags are embedded in said string material

10. The product of claim 1, further comprising a radio frequency blocking material selectively places on said string material.

11. A method comprising:
laying a string material along a path through an infrastructure, said string material comprising Radio Frequency Identification (RFID) tags placed at intervals along a length of said string material, each said RFID tag having an identifier stored therein for transmission to identify that RFID tag to a reader;
in which said path is selected to correspond with a path to be followed through said infrastructure by a computer-driven mobile device.

12. The method of claim 11, in which said string material is secured along said path by an adhesive substance placed on said string material.

13. The method of claim 11, in which said string material is placed in existing ductwork within said infrastructure.

14. The method of claim 11, further comprising guiding a computer-driven mobile device along said path through said infrastructure by reading said identifiers of said RFID tags.

15. The method of claim 14, further comprising identifying, for said mobile device, a first identifier corresponding to an RFID tag at a starting point and a second identifier corresponding to an RFID tag at a destination point.

16. The method of claim 15, further comprising identifying a series of identifiers corresponding to a sequence of RFID tags along said path.

17. The method of claim 16, in which a range of one of said RFID tags overlaps a range of an adjacent RFID tag along a length said string material.

18. The method of claim 15, in which identifying said first and second identifiers comprises reading a printed identifier on said string material adjacent to said RFID tags at said starting and destination points.

19. A computer-driven mobile device comprising:
a Radio Frequency Identification (RFID) tag reader;
a memory; and
a processor;
in which said processor is configured to cause said computer-driven mobile device to traverse an infrastructure based on information acquired by said RFID tag reader, said infrastructure comprising a string material placed along a route of said infrastructure, said string material comprising:
RFID tags placed at relatively regular intervals along a length of said string material;
in which identification numbers associated with said RFID tags follow a sequence along said length of said string material.

20. The mobile device of claim 18, in which said processor is configured to process a first identification number for a staring RFID along said path and a second identification number for a destination RFID along said path.
